(19) United States
(12) Patent Application Publication
(10) Pub. No.: US 2026/0253349 A1
(43) Pub. Date: Aug. 27, 2026

(54) METHOD, APPARATUS, TERMINAL AND STORAGE MEDIUM FOR INFORMATION DISPLAY

(71) Applicant: Beijing Zitiao Network Technology Co., Ltd., Beijing (CN)

(72) Inventors: Xiangyu HUANG, Beijing (CN); Zhihao XU, Beijing (CN); Mengqi TU, Beijing (CN); Pingfei FU, Beijing (CN); Xiang HE, Beijing (CN); Peipei WU, Beijing (CN); Liyue JI, Beijing (CN); He CHENG, Beijing (CN)

(21) Appl. No.: 18/871,015

(22) PCT Filed: Apr. 27, 2023
(86) PCT No.: PCT/CN2023/091174

§ 371 Date: Dec. 2, 2024

(30) Foreign Application Priority Data
May 31, 2022 (CN) 202210612150.2

(51) Int. Cl. G06T 19/20

(52) U.S. Cl. CPC G06T 19/20; G06T 2219/2004; G06T 2219/2016

(57) ABSTRACT

The present disclosure provides an information display method, apparatus, terminal and storage medium. The information display method comprises: determining bullet comment information to be displayed and a bullet comment space in a display space, wherein the display space is configured to display a target image, and the bullet comment space is a predetermined space area in the display space; displaying the bullet comment information in the bullet comment space; wherein a circular or curved bullet track is arranged in advance in the bullet comment space, and at least part of the bullet comment information bends along the bullet track to form curved bullet comments. In the information display method provided by the embodiments of the present disclosure, curved bullet comments are displayed, so that the bullet comments extend along a curve in their extension direction, thereby forming surround effects in spatial vision.

### CROSS REFERENCE TO RELATED APPLICATION(S)

This application claims priority to Chinese Patent Application No. 202210612150.2, filed with the Chinese Patent Office on May 31, 2022 and entitled “METHOD, APPARATUS, TERMINAL AND STORAGE MEDIUM FOR INFORMATION DISPLAY”, the disclosure of which is incorporated herein by reference in its entities.

### FIELD

The present disclosure relates to the computer technology field, and in particular, to an information display method, apparatus, terminal and storage medium.

### BACKGROUND

During video playing, users who watch the video can send bullet comments, which can be displayed on the video. By sending bullet comments, the fun of the video can be enhanced.

### SUMMARY

The present disclosure provides an information display method, apparatus, terminal and storage medium.

The present disclosure adopts the following technical solutions.

In some embodiments, the present disclosure provides an information display method, comprising:
determining bullet comment information to be displayed and a bullet comment space in a display space, wherein the display space is configured to display a target image, and the bullet comment space is a predetermined space area in the display space;
displaying the bullet comment information in the bullet comment space;
wherein a circular or curved bullet track is arranged in advance in the bullet comment space, and at least part of the bullet comment information bends along the bullet track to form curved bullet comments.

In some embodiments, the present disclosure provides an information display apparatus, comprising:
a determining unit configured for determining bullet comment information to be displayed and a bullet comment space in a display space, wherein the display space is configured to display a target image, and the bullet comment space is a predetermined space area in the display space;
a display unit configured for displaying the bullet comment information in the bullet comment space;
wherein a circular or curved bullet track is arranged in advance in the bullet comment space, and at least part of the bullet comment information bends along the bullet track to form curved bullet comments.

In some embodiments, the present disclosure provides a terminal comprising: at least one memory and at least one processor;
wherein the memory is for storing program code, and the processor is for calling the program code stored in the memory to perform the method described above.

In some embodiments, the present disclosure provides a computer readable storage medium, wherein the computer readable storage medium is for storing program code which, when executed by a processor, causes the processor to perform the method described above.

In the information display method provided by the embodiments of the present disclosure, bullet comments are displayed in a curved way, so that the bullet comments extend along the curve line in their extension direction, thereby forming surround effects in spatial vision.

### BRIEF DESCRIPTION OF THE DRAWINGS

Through the more detailed description of detailed implementations with reference to the accompanying drawings, the above and other features, advantages and aspects of respective embodiments of the present disclosure will become more apparent. The same or similar reference numerals represent the same or similar elements throughout the figures. It should be understood that the figures are merely schematic, and components and elements are not necessarily drawn scale.

FIG. 1 is a schematic diagram of using a virtual reality device in the embodiments of the present disclosure.

FIG. 2 is a flowchart of an information process method in the embodiments of the present disclosure.

FIG. 3 is a front view of display effects of bullet comment information in the embodiments of the present disclosure.

FIG. 4 is a front view of display effects of bullet comment information in the embodiments of the present disclosure.

FIG. 5 is a front view of display effects of bullet comment information in the embodiments of the present disclosure.

FIG. 6 is a top view of a display location of bullet comment information in FIG. 5 in the embodiments of the present disclosure.

FIG. 7 is a front view of display effects of bullet comment information in the embodiments of the present disclosure.

FIG. 8 is a front view of display effects of bullet comment information in the embodiments of the present disclosure.

FIG. 9 is a top view of a display location of bullet comment information in FIG. 8 in the embodiments of the present disclosure.

FIG. 10 is a structural schematic diagram of an electronic device in the embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in method implementations of the present disclosure may be performed in a different order and/or in parallel. In addition, the method implementations may comprise an additional step and/or omit a step which is shown. The scope of the present disclosure is not limited in this regard.

The term “comprise”, and its variants used here are to be read as open terms that mean “include, but is not limited to.” The term “based on” is to be read as “based at least in part on.” The term “one embodiment” are to be read as “at least one embodiment.” The term “another embodiment” is to be read as “at least one other embodiment.” The term “some embodiments” are to be read as “at least some embodiments.” Other definitions will be presented in the description below.

Note that the concepts “first,” “second” and so on mentioned in the present disclosure are only for differentiating different apparatuses, modules or units rather than limiting the order or mutual dependency of functions performed by these apparatuses, modules or units.

Note that the modification “one” mentioned in the present disclosure is illustrative rather than limiting, and those skilled in the art should understand that unless otherwise specified, it should be understood as “one or more.”

Names of messages or information interacted between a plurality of apparatuses in the implementations of the present disclosure are merely for the illustration purpose, rather than limiting the scope of these messages or information.

With reference to the accompanying drawings, a detailed description will be presented below to the solution provided by the embodiments of the present application

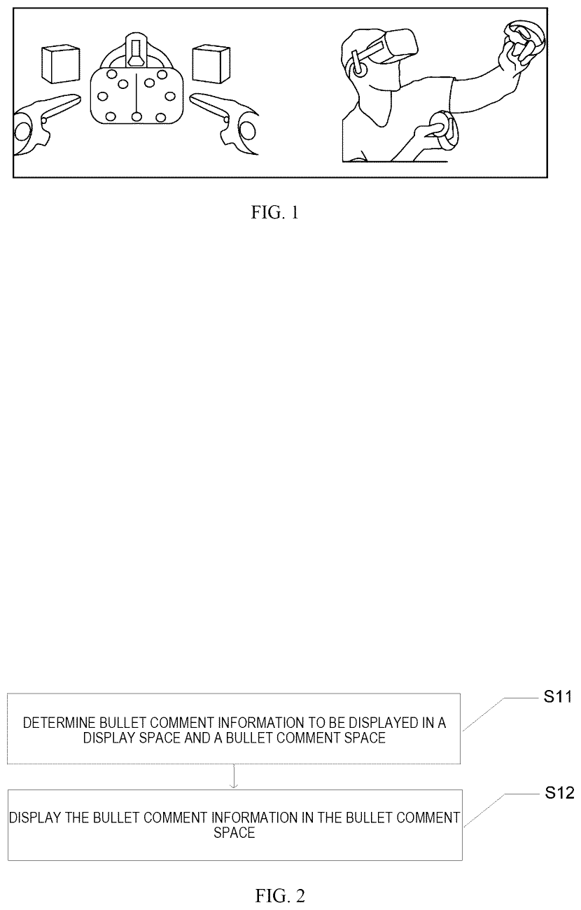

As shown in FIG. 1, users can enter a virtual reality space through intelligent terminal devices such as head mounted VR glasses, and control their virtual characters (Avatar) in the virtual reality space to engage in social interaction, entertainment, learning, remote work and the like with other virtual characters controlled by other users.

The virtual reality space can be a simulated environment of the real world, a semi simulated and semi fictional virtual scene, or a purely fictional virtual scene. The virtual scene can be any of a two-dimensional virtual scene, 2.5-dimensional virtual scene, or three-dimensional virtual scene. The dimensions of the virtual scene are not limited by the embodiments of the present application. For example, the virtual scene can include sky, land, ocean, etc. The land can include environmental elements such as deserts and cities, and the user can control a virtual object to move in the virtual scene.

In an embodiment, in the virtual reality space, the user can perform related interactive operations through a controller, which can be a controller. For example, the user can control related operations by manipulating buttons on the controller. Of course, in other embodiments, the control of target objects in virtual reality devices can further be realized without using controller but using gestures, speech, or multimodal control modes.

In an embodiment, with the development of virtual reality technology, performers can leverage this technology for virtual reality performances, such as holding virtual reality concerts or live broadcasts. For the audience, by means of virtual reality devices, they can immerse themselves in experiences similar to real live performances. For example, a virtual reality space model may be built for performers through the virtual reality technology, and a virtual reality environment for the concert can be calculated and generated based on the space model. In addition, technologies such as auditory perception, tactile perception, motion perception, and even taste perception and olfactory perception can be provided to achieve the integration of virtual environments, interactive three-dimensional dynamic views, and simulation of physical behavior, allowing users to immerse themselves in the simulated virtual reality environment.

In some embodiments of the present disclosure, an information display method is proposed, which can be used for virtual reality devices. Virtual reality devices are terminals that achieve virtual reality effects, and can typically be provided in the form of glasses, head mounted displays (HMDs) and contact lenses for visual perception and other forms of perception. Of course, the implementation form of virtual reality devices is not limited to this, and can be further miniaturized or enlarged as needed.

The virtual reality devices described in the embodiments of the present disclosure can include, without limitation to, the following types:

PC-based virtual reality (PCVR) devices that utilize the PC to perform calculations related to virtual reality functions and data output, and external PC-based virtual reality devices that utilize the data output from the PC to achieve virtual reality effects.

Mobile virtual reality devices that support setting mobile terminals (such as smartphones) in various ways (such as a head-mounted display that is provided with a specialized card slot). Through wired or wireless connections with the mobile terminal, the mobile terminal performs calculations related to virtual reality functions and outputs data to the mobile virtual reality device, such as watching virtual reality videos through APPs on the mobile terminal.

All-in-one virtual reality devices with a processor for performing calculations related to virtual functions, thus having independent virtual reality input and output functions, without the need to connect to a PC or mobile terminal, and with a high degree of freedom of use.

With the development of virtual reality technology, people have begun to use virtual reality technology for virtual performances. During virtual performances, users can post bullet comment information while watching the performance, which is displayed in the virtual reality space. In the related art, bullet comment information is often displayed on the view plane, which lacks three-dimensional sense and does not well match with the three-dimensional space of the virtual reality space.

As shown, FIG. 2 is a flowchart of an information display method of the embodiments of the present disclosure, comprising the following.

S11: Determining bullet comment information to be displayed and a bullet comment space in a display space.

In some embodiments, the display space is configured to display a target image, and the bullet comment space is a preset spatial area in the display space. In some embodiments, the display space is a virtual reality space, and the target image is a virtual reality image. In some embodiments, the bullet comment space can be a three-dimensional area in the virtual reality space, used to display bullet comment information. Of course, a virtual reality image in the virtual reality space may be simultaneously displayed in the bullet comment space, which can be used for more than just displaying the bullet comment information. The bullet comment information can be information sent by the current user as well as other users. In the display space, there may be images of virtual reality characters. The virtual reality characters can be virtual or real images of live streamers and other performers, who perform in the virtual reality space. The current user and other users can watch the performance and send bullet comment information through virtual reality devices in the virtual reality space.

S12: Displaying the bullet comment information in the bullet comment space.

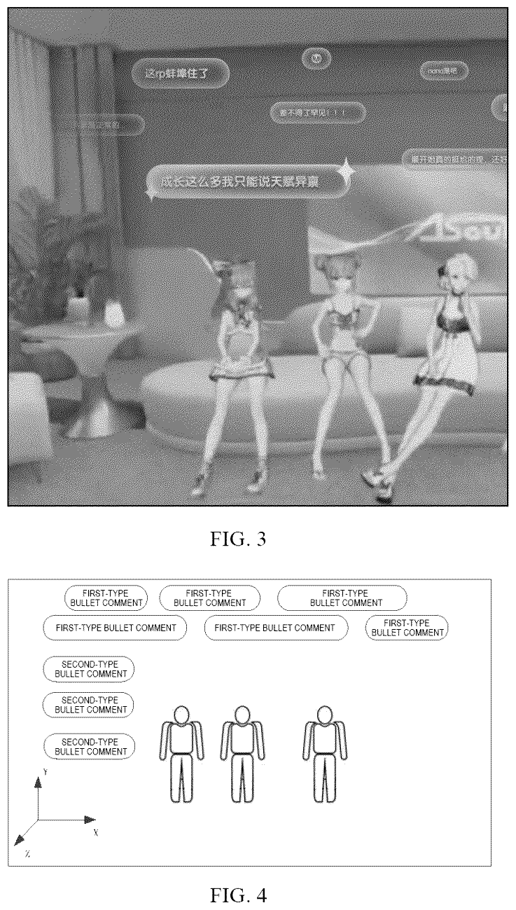

In some embodiments, circular or arc-shaped bullet tracks are set in the bullet comment space in advance, and at least part of the bullet comment information bends along the bullet tracks to form curved bullet comments. In some embodiments, one or more bullet tracks may be set in the bullet comment space. The bullet tracks are usually invisible and can be a movement path of the bullet comment information or a collection of display locations of the bullet comment information. In this embodiment, since the bullet track is displayed in a three-dimensional bullet comment space, the bullet track can be circular or arc-shaped. In this way, the bullet comment information bends as the bullet track bends, forming bent curved-surface bullet comments, as if there were one or more curved surfaces in the bullet comment space and bullet comments fit on the curved surface. For example, reference may be made to FIG. 3, in which the display state of bullet comment information is displayed in the virtual reality space by way of example. The bullet comment information, extending along a horizontal direction, can be arranged in a vertical direction, and can be bent in directions perpendicular to the horizontal and vertical directions. The axis around which the bullet comment information bends is in a vertical direction. For example, in FIG. 3, the bullet comment information bends in a form protruding or depressing towards the user, forming curved bullet comments. For example, a cylindrical space can be set in the display space, with a cylindrical side of the cylindrical space facing the user, and the bullet comment information is displayed on the cylindrical side.

In some embodiments, by displaying curved bullet comments, the bullet comments are caused to extend along a curve in its extension direction, forming surround effects in spatial vision instead of extending on a straight line. Displaying the curved bullet comments with surround effects in the three-dimensional display space can improve the user's sensory experience, is suitable for display in the three-dimensional virtual reality space and can enhance the viewing experience in the three-dimensional space. However, in the related art, bullet comment information is displayed on a plane, which is not suitable for information display in the three-dimensional space and does not fully utilize three-dimensional advantages of the three-dimensional space.

In some embodiments of the present disclosure, the axial direction of the bullet track is the vertical direction in the display space, the bullet track bends along a first direction that is the display direction of the target image. In some embodiments, with reference to FIG. 4, the x-direction is the horizontal direction in the display space, the y-direction is the vertical direction in the display space, the z-direction is perpendicular to the x and y directions, the z-direction is the depth direction, the axial direction of the bullet track can be parallel to the y-direction, the z-direction can be a radial direction of the circle where the bullet track is located, and the first direction can be a radial direction of the circle where the bullet track is located. In this way, the bullet comment information forms a curved state of recessing inward or protruding outward in the depth direction. When watching, the user can feel the bullet comment information protruding or recessing towards them, thereby improving the stereoscopic viewing effect.

In some embodiments of the present disclosure, the number of the bullet tracks is at least two, and there exist at least two bullet tracks with different locations in the first direction. In some embodiments, bullet tracks can be arranged parallel to each other, the number of bullet tracks can be two or more, and there are bullet tracks with different locations in the first direction, so bullet tracks can have different depths. Further, the depth of bullet comment information displayed on different bullet tracks can be different, and the distance between bullet comment information and the user in the z-direction can be different, and some of bullet comment information is closer to the user in the z-direction.

In some embodiments of the present disclosure, the bullet comment information includes at least one of a first-type bullet comment and a second-type bullet comment, and the bullet comment space includes at least one of a first bullet comment space and a second bullet comment space; wherein the first-type bullet comment information is displayed in the first bullet comment space, and the second-type bullet comment information is displayed in the second bullet comment space. In some embodiments, the bullet comment information can have different types. For example, the first-type bullet comment information includes interactive information, which can be information sent by users when interacting with performers (such as streamers), while the second-type bullet comment information can include non-interactive information. For the sent bullet comment information, it can be recognized as the first or second type, and then displayed in the corresponding first or second bullet comment space. For example, as shown in FIGS. 4 and 5, the top space area of the performer can be set as the first bullet comment space, and the side space of the performer (left side in FIGS. 4 and 5) can be set as the second bullet comment space. Different bullet comment information can be displayed in different bullet comment spaces, so that the user can see bullet comment information in a targeted manner and can focus on the second bullet comment space during interaction with the performer. It is possible to avoid interactive information being submerged in huge non-interactive bullet comment information, increase the interaction efficiency and improve the interaction experience.

In some embodiments of the present disclosure, the first bullet comment space has at least two bullet tracks with different locations in the first direction. In some embodiments, the first direction is the display direction of the target image in the display space. In some embodiments, the first direction is the depth direction, which can be understood as the near-far distance direction of the user. There are bullet tracks with different locations in the first direction in the first bullet comment space, so that the distance between the bullet comment information displayed on these bullet tracks and the user is different, and the user can feel the three-dimensional displacement effects.

In some instances, spacing distances between adjacent bullet comment information on the bullet track is not exactly the same. In some embodiments, two or more bullet comment information can be displayed on the bullet track, and the bullet comment information has spaced distances on the bullet track, which can be not fixed. For example, the spacing distance can be directly or inversely proportional to the length of the bullet comment information. Of course, in some embodiments, the spacing distance can also be set to a fixed value. Alternatively, the spacing distance can be automatically adjusted based on the amount of bullet comment information, e.g., can be automatically reduced when there is a large amount of bullet comment information, and can be automatically increased when there is a small amount of bullet comment information.

In some embodiments of the present disclosure, displaying the bullet comment information in the bullet comment space comprises: controlling the first-type bullet comment to move along the bullet track in the first bullet comment space. In some embodiments, the bullet track is the motion track of the bullet comment information. The first-type bullet comments are moved along the bullet track in the first bullet comment space. Since the bullet track is circular or curved, surround stereoscopic effects will be formed with the movement of the first-type bullet comments. For example, the bullet track can be an outer circular edge on a hemisphere, allowing the first-type bullet comments to move along the hemisphere to form curved bullet comments. In some embodiments, the circular surface where the bullet track is located can be parallel to the horizontal plane. The first-type bullet comments can move in a direction from right to left, or from left to right, of course.

In some embodiments of the present disclosure, displaying the bullet comment information in the bullet comment space comprises: when the first-type bullet comments enters the first bullet comment space, gradually increasing a size of the first-type bullet comments or gradually reducing a transparency of the first-type bullet comments. In some embodiments of the present disclosure, as the first type leaves the first bullet comment space, the size of the first-type bullet comments gradually reduces and/or the transparency of the first-type bullet comments gradually increases.

In some embodiments, the initial size of the first-type bullet comments before entering the first bullet comment space can be smaller than its size after completely entering the first bullet comment space, for example, the initial size is 0.6, and the size after completely entering the first bullet comment space is 1. When the first-type bullet comments enters the first bullet comment space, the size of the first-type bullet comments is increased, and its transparency is reduced, thus gradually revealing the first-type bullet comments. When the first-type bullet comments leave the first bullet comment space, the operation is reversed, thus gradually ceasing to display the first-type bullet comments and reducing the size thereof. A mask can be set at the starting and ending locations of the bullet track respectively. When entering the first bullet comment space, the first-type bullet comments come out of the mask that obscures the first-type bullet comments. When leaving the first bullet comment space, the first-type bullet comments can enter the mask and be obscured.

In some embodiments, displaying the bullet comment information in the bullet comment space comprises: in response to the first-type bullet comments sent by a current user, distinguishing a display style of the first-type bullet comments sent by the current user from a display style of other first-type bullet comments. In some embodiments, for the current user, they pay more attention to the bullet comments they send. Therefore, the first-type bullet comments sent by the current user can be distinguished from the first-type bullet comments sent by other users by highlighting or changing the color. Therefore, the bullet comment information watched by different users may not be exactly the same. For different users, the display style of the first-type bullet comments posted by them will be different from the first-type bullet comments sent by other users.

In some embodiments, displaying the bullet comment information in the bullet comment space comprises: in response to the first-type bullet comments sent by the current user, displaying, in priority, the first-type bullet comments sent by the current user in the first bullet comment space. In some embodiments, the first-type bullet comments can be displayed in chronological order, while for the current user, they are more concerned about the bullet comment information posted by themselves. Therefore, the first-type bullet comments sent by the current user will be displayed first, e.g., immediately placed at the top of a sequence of the first-type bullet comments to be displayed and thus will be immediately displayed. It can be seen that the bullet comment information watched by different users may not be exactly the same. The bullet comment information watched by respective users can be determined by the user, and the bullet comment information posted by each user will be displayed in priority.

In some embodiments, displaying the bullet comment information in the bullet comment space comprises: adjusting the number of bullet tracks in the first bullet comment space based on a display effect of the first-type bullet comments. In some embodiments, adjusting the number of bullet tracks based on the display effects can first judge whether there is obstruction between the first-type bullet comment information or not, and if yes, automatically increase the number of bullet tracks to reduce obstruction. Considering the particularity of three-dimensional bullet comment space, the number of bullet tracks in the first direction may be adjusted, as the number of bullet tracks that can be added on a display plane is limited. However, in the present disclosure, the number of bullet tracks in the first direction can be increased utilizing the particularity of three-dimensional space.

In some examples of the present disclosure, displaying the bullet comment information in the bullet comment space comprises: displaying the first-type bullet comments at at least one predetermined location on the bullet track, and ceasing to display the first-type bullet comments after being displayed for a predetermined time to display the next first-type bullet comments.

In some examples, the first-type bullet comments cannot move on the bullet track, and a fixed predetermined location can be provided on the bullet track. The first-type bullet comments can appear in place at the predetermined location, for example, in the form of bubbles containing the first-type bullet comments inside. After a predetermined period of time (such as 5 seconds), the transparency of the first-type bullet comments gradually increases and then is ceased to display, and the next first-type bullet comments is displayed. When the first-type bullet comments appear or disappears, the corresponding process animation can be displayed. For example, when the first-type bullet comments appear, the bubble gradually expands to display the first-type bullet comments, and when the first-type bullet comments disappear, the bubble bursts to gradually cease to display the first-type bullet comments.

In some examples of the present disclosure, displaying the bullet comment information in the bullet comment space comprises: in response to the first-type bullet comments sent by a current user, displaying the first-type bullet comments sent by the current user on the most forward bullet track in the first direction in the first bullet comment space. In some embodiment, the most forward bullet track in the first direction is a bullet track with the closet distance to the current user in the depth direction. Therefore, the current user can get close to the first-type bullet comments sent by themselves, improving the user experience.

In some examples of the present disclosure, displaying the bullet comment information in the bullet comment space comprises: evenly distributing the first-type bullet comments in the first bullet comment space according to the post time. In some embodiments, the first-type bullet comments are evenly distributed in time and space within the first bullet comment space, with minimal blocking. When the density of the first-type bullet comments reaches a predetermined value, the first-type bullet comments are allowed to block each other. In some embodiments, the first-type bullet comments are displayed sequentially in the first bullet comment space according to the order of post time, and are evenly distributed in the first bullet comment space.

In some embodiments, the display location of the first-type bullet comment information does not move with the current user's movement. The location of the first-type bullet comment information in the bullet comment space is set in advance and will not be affected by the current user's movement.

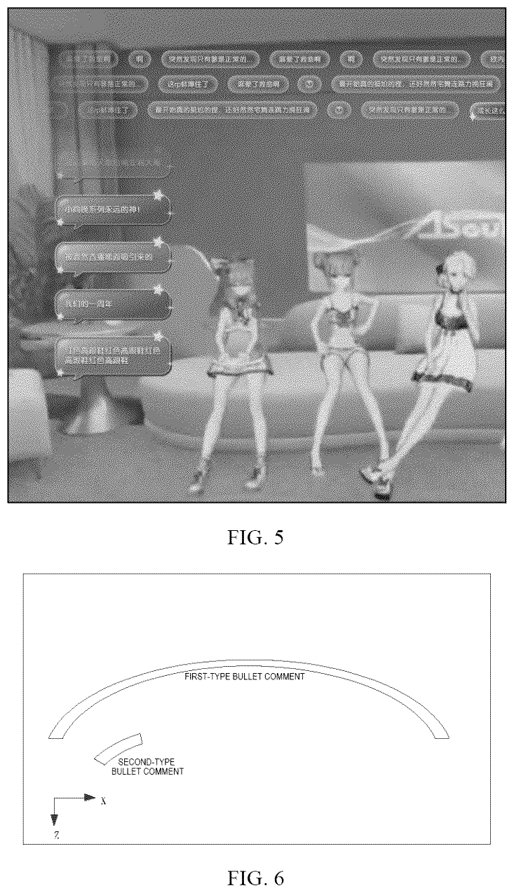

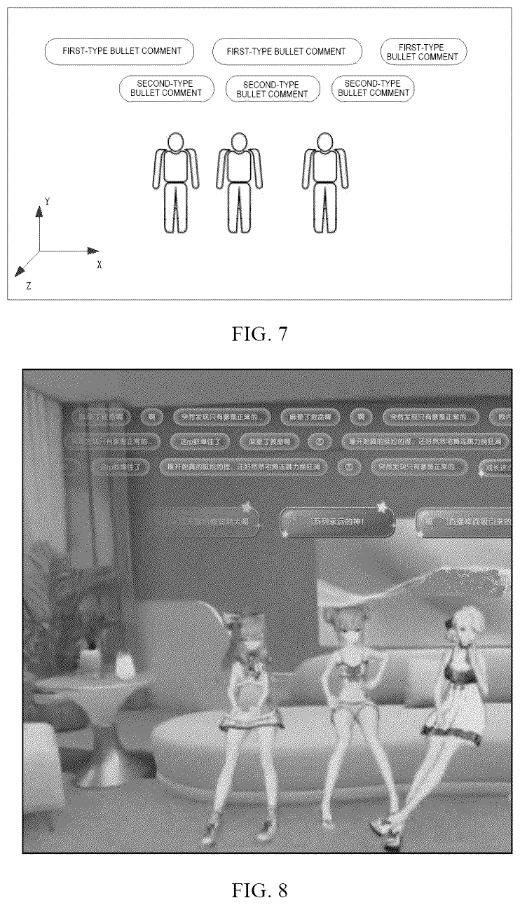

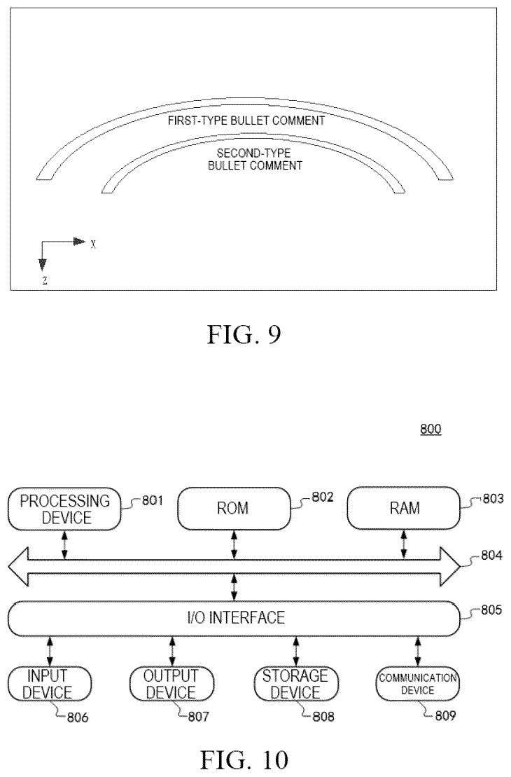

In some embodiments of the present disclosure, displaying the bullet comment information in the bullet comment space comprises: a bullet track in the second bullet comment space being located on the side of the bullet track in the first bullet comment space facing the first direction. In some embodiments, as shown in FIG. 6, this figure shows the positional relationship between the second and first types of bullet comments in the first direction in FIG. 5. The first direction can be the z-direction in FIG. 6, and the bullet track where the second-type bullet comments are located is closer to the user in the first direction. Since interactive information receives more attention from the user, it is displayed at a location closer to the user. In some embodiments, as shown in FIG. 5, the second-type bullet comments can be displayed in the lateral space of the performer's image in the display space. In other embodiments, as shown in FIGS. 7 and 8, the second-type bullet comments can also be displayed in the space above the performer's image's head in the display space, and the second bullet comment space can be located vertically below the first bullet comment space. As shown in FIG. 9, the figure shows a top view of the location of the bullet comment information in FIG. 8. It can be seen that the first and second types of bullet comments can be displayed on parallel bullet tracks, while the second-type bullet comments can be located closer to the user in the first direction.

In some embodiments of the present disclosure, displaying the bullet comment information in the bullet comment space comprises: scrolling the second-type bullet comments onto the bullet track in the second bullet comment space. In some embodiments, the second-type bullet comments can move horizontally from right to left or from left to right. In some embodiments, for the second-type bullet comments, their bullet track has surround effects in terms of spatial visualization, rather than moving along a straight line in the second bullet comment space, thereby forming curved bullet comments. In some embodiments, as shown in FIGS. 7 and 8, the second-type bullet comments can be displayed on a bullet track, where the speed of the bullet comment information on that track and the location of that track can be adjusted. The user can change the location of the bullet track according to their own needs and preferences. The second-type bullet comments can be displayed on the bullet track in a way that is either center-aligned or top-aligned.

In some embodiments of the present disclosure, displaying the bullet comment information in the bullet comment space comprises: adjusting the number of bullet tracks in the second bullet comment space and/or adjusting the spacing distance between the second-type bullet comments on bullet tracks based on the display effects of the second-type bullet comments. In some embodiments, it can be determined based on the display effects whether the second-type bullet comments in the second bullet comment space block each other or the density of bullet comments is greater than the first predetermined value. If they block each other or the density of bullet comments is greater than the predetermined value, the number of bullet tracks will be increased or the spacing distance on the bullet tracks will be reduced. If the second-type bullet comments in the second bullet comment space do not block each other and the density of bullet comments is less than a second predetermined value, the number of bullet tracks will be reduced or the spacing distance will be reduced, where the second predetermined value is less than the first predetermined value.

In some embodiments of the present disclosure, displaying the bullet comment information in the bullet comment space comprises: simultaneously displaying a maximum of n second-type bullet comments on a bullet track in the second bullet comment space, and after a new second-type bullet comment is generated, ceasing to display an earliest displayed second-type bullet comments among the displayed second-type bullet comments and displaying a newly generated second-type bullet comment on the bullet track. In some embodiments, taking the movement of a bullet comment from right to left as an example, it may be set that a maximum of n second-type bullet comments may be simultaneously displayed on a bullet track, wherein N is not less than 1, e.g., not less than 5. When the first second-type bullet comment appears, it can stop in the middle of the bullet track. The second second-type bullet comment and the existing first second-type bullet comment form a set and are center-displayed, and so on and so forth, until the number of second-type bullet comments reaches n. At this point, if a new second-type bullet comment appears, the earliest presented second-type bullet comment is ceased to display and is replaced with the new second-type bullet comment.

In some embodiments of the present disclosure, displaying the bullet comment information in the bullet comment space comprises: gradually increasing a size of the second-type bullet comment, reducing a transparency of the second-type bullet comment, and/or increasing the movement speed of the second-type bullet comment as the second-type bullet comment enters the second bullet comment space. In some embodiments of the present disclosure, displaying the bullet comment information in the bullet comment space comprises: gradually reducing a size of the second-type bullet comments, increasing a transparency of the second-type bullet comment, and/or reducing the movement speed of the second-type bullet comment as of the second-type bullet comment leaves the second bullet comment space. In some embodiments, when the second-type bullet comment enters and leaves the second bullet comment space, its size, movement speed, transparency and other parameters can be changed, thereby forming a transition animation and improving the display effects.

In some embodiments of the present disclosure, displaying the bullet comment information in the bullet comment space comprises: scrolling the second-type bullet comment in the form of a curved bullet comment along a second direction, the second direction being perpendicular to the first direction. In some embodiments, as shown in FIGS. 4 and 5, the first-type bullet comment can move in the x direction or the opposite direction, while the second-type bullet comment can scroll in the y direction or the opposite direction. Since the first and second directions are perpendicular to each other, the user can quickly distinguish between the first-type bullet comment and the second-type bullet comment, and selectively view bullet comment information.

In some embodiments of the present disclosure, displaying the bullet comment information in the bullet comment space comprises: simultaneously displaying a maximum of m second-type bullet comments in the second bullet comment space, and after a new second-type bullet comment is generated, ceasing to display an earliest displayed second-type bullet among the displayed second-type bullet comments, and displaying a newly generated second-type bullet comment in the second bullet comment space. In some embodiments, the second-type bullet comment can scroll vertically from bottom to top in the display space. The second bullet comment space is the area space on the left side in FIGS. 4 and 5, where a maximum of m second-type bullet comments can be displayed simultaneously, M is not less than 1, e.g., it is not less than 5. As lower second-type bullet comments scroll upward, upper second-type bullet comments are replaced one by one.

In some embodiments of the present disclosure, displaying the bullet comment information in the bullet comment space comprises: adjusting the spacing distance of second-type bullet comments along the second direction in the second bullet comment space and/or the number of second-type bullet comments in the second direction based on display effects of the second-type bullet comments. In some embodiments, when the number of second-type bullet comments is greater than the first value, the spacing distance of the second-type bullet comments along the second direction can be reduced, or the number of second-type bullet comments in the second direction can be increased, so that more of second-type bullet comments can be displayed simultaneously. Similarly, when the number of second-type bullet comments is less than the second value, the spacing distance of the second-type bullet comments along the second direction can be increased, or the number of second-type bullet comments in the second direction can be reduced, thereby avoiding the situation where there is no second-type bullet comment.

An information display device is proposed in some embodiments of the present disclosure, which can be a virtual reality device, comprising: a determining unit configured for determining bullet comment information to be displayed and a bullet comment space in a display space, wherein the display space is configured to display a target image, and the bullet comment space is a predetermined space area in the display space;
a display unit configured for displaying the bullet comment information in the bullet comment space;
wherein a circular or curved bullet track is arranged in advance in the bullet comment space, and at least part of the bullet comment information bends along the bullet track to form curved bullet comments.

In some embodiments, an axial direction of the bullet track is a vertical direction in the display space, the bullet track bends along a first direction, and the first direction is a display direction of the target image; and/or the number of bullet tracks is at least two, and there are at least two bullet tracks with different locations in the first direction.

In some embodiments, the bullet comment information comprises at least one of a first-type bullet comment and a second-type bullet comment, and the bullet comment space comprises at least one of a first bullet comment space and a second bullet comment space; wherein the first-type bullet comment is displayed in the first bullet comment space, and the second-type bullet comment is displayed in the second bullet comment space.

In some embodiments, at least one of the following conditions is met: the first-type bullet comment comprises interactive information; the second-type bullet comment comprises non interactive information; the first bullet comment space has at least two bullet tracks with different locations in the first direction; spacing distances between adjacent bullet comment information on the bullet track are not exactly the same; wherein the first direction is a display direction of a target image in the display space.

In some embodiments, displaying the bullet comment information in the bullet comment space comprises at least one of: controlling the first-type bullet comment to move along the bullet track in the first bullet comment space; gradually increasing a size of the first-type bullet comment and/or gradually reducing a transparency of the first-type bullet comment if the first-type bullet comment enters the first bullet comment space; and gradually reducing a size of the first-type bullet comment and/or gradually increasing a transparency of the first-type bullet comment if the first-type bullet comment leaves the first bullet comment space.

In some embodiments, displaying the bullet comment information in the bullet comment space comprises at least one of: in response to a first-type bullet comment sent by a current user, distinguishing the display style of the first-type bullet comment sent by the current user from the display style of other first-type bullet comments; in response to the first-type bullet comment sent by the current user, displaying in priority the first-type bullet comment sent by the current user in the first bullet comment space; and adjusting the number of bullet tracks in the first bullet comment space based on a display effect of the first-type bullet comment.

In some embodiments, displaying the bullet comment information in the bullet comment space comprises: displaying the first-type bullet comment at at least one predetermined location on the bullet track, and ceasing to display the first-type bullet comment after being displayed for a predetermined time, so as to display a next first-type bullet comment; in response to a first-type bullet comment sent by a current user, displaying the first-type bullet comment sent by the current user on the most forward bullet track in the first direction in the first bullet comment space; and evenly distributing the first-type bullet comments in the first bullet comment space based on the post time.

In some embodiments, displaying the bullet comment information in the bullet comment space comprises at least one of: a bullet track in the second bullet comment space being located on a side of a bullet track in the first bullet comment space facing a first direction; scrolling-displaying the second-type bullet comment on a bullet track in the second bullet comment space; adjusting the number of bullet tracks in the second bullet comment space and/or adjusting a spacing distance between second-type bullet comments on the bullet tracks based on display effects of the second-type bullet comments; simultaneously displaying a maximum of n second-type bullet comments on bullet tracks in the second bullet comment space, and after a new second-type bullet comment is generated, ceasing to display an earliest displayed second-type bullet comment among displayed second-type bullet comments and displaying a newly generated second-type bullet comment on the bullet track; gradually increasing a size of the second-type bullet comment, reducing a transparency of the second-type bullet comment and/or increasing the movement speed of the second-type bullet comment if the second-type bullet comment enters the second bullet comment space; and gradually reducing a size of the second-type bullet comment, increasing a transparency of the second-type bullet comment and/or reducing the movement speed of the second-type bullet comment if the second-type bullet comment leaves the second bullet comment space.

In some embodiments, displaying the bullet comment information in the bullet comment space comprises at least one of: scrolling-displaying the second-type bullet comment in the form of a curved bullet comment along a second direction, the second direction being perpendicular to the first direction; simultaneously displaying a maximum of m second-type bullet comments in the second bullet comment space, and after a new second-type bullet comment is generated, ceasing to display an earliest displayed second-type bullet comment among displayed second-type bullet comments and displaying a newly generated second-type bullet comment in the second bullet comment space; and adjusting a spacing distance between second-type bullet comments along the second direction in the second bullet comment space and/or adjusting the number of bullet tracks in the second direction based on display effects of the second-type bullet comments.

In some embodiments, the display space is virtual reality space, and the target image is a virtual reality image.

For the apparatus embodiments, as they basically correspond to the method embodiments, reference can be made to the description of the method embodiments for relevant information. The apparatus embodiments described above are only illustrative, and the modules described as separate modules may or may not be separate. The objectives of the solution of the embodiments may be achieved by selecting some or all of the modules according to actual needs. Those of ordinary skill in the art can understand and implement the solution without the exercise of creative efforts.

The method and apparatus of the present disclosure have been illustrated based on the embodiments and application examples. In addition, the present disclosure further provides a terminal and a storage medium, which are described below.

With reference to FIG. 10, this figure shows a structural schematic diagram of an electronic device (e.g., terminal device or server) 800 that is applicable to implement the embodiments of the present disclosure. The terminal device in the embodiments of the present disclosure may include, without limitation to, a mobile terminal such as a mobile phone, a notebook computer, a digital broadcast receiver, a personal digital assistant (PDA), a portable Android device (PAD), a portable multimedia player (PMP), an on-board terminal (e.g., an on-board navigation terminal) and the like, as well as a fixed terminal such as digital TV, a desktop computer and the like. The electronic device shown in this figure is merely an example and should not be construed as bringing any restriction on the functionality and usage scope of the embodiments of the present disclosure.

As shown in FIG. 10, the electronic device 800 may comprise a processing device (e.g., a central processor, a graphics processor) 801 which is capable of performing various appropriate actions and processes to realize the method of table processing as described in the embodiments of the present disclosure in accordance with programs stored in a read only memory (ROM) 802 or programs loaded from a storage device 808 to a random access memory (RAM) 803. In the RAM 803, there are also stored various programs and data required by the electronic device 800 when operating. The processing device 801, the ROM 802 and the RAM 803 are connected to one another via a bus 804. An input/output (I/O) interface 805 is also connected to the bus 804.

Usually, the following units may be connected to the I/O interface 805: an input device 806 including a touch screen, a touch pad, a keyboard, a mouse, a camera, a microphone, an accelerometers, a gyroscope, or the like; an output device 807, such as a liquid-crystal display (LCD), a loudspeaker, a vibrator, or the like; a storage device 808, such as a magnetic tape, a hard disk or the like; and a communication device809. The communication device809 allows the electronic device 800 to perform wireless or wired communication with other device so as to exchange data with other device. While FIG. 8 shows the electronic device 800 with various units, it should be understood that it is not required to implement or have all of the illustrated units. Alternatively, more or less units may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication device809, or installed from the storage device 808, or installed from the ROM 802. The computer program, when executed by the processing device 801, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

In some implementations, clients and servers can communicate using any currently known or future developed network protocol, such as HTTP (HyperText Transfer Protocol), and can interconnect with any form or medium of digital data communication (e.g., communication networks). Examples of communication networks include local area networks (“LANs”), wide area networks (“WANs”), the Internet, and end-to-end networks (e.g., ad hoc end-to-end networks), as well as any currently known or future developed networks.

The above computer readable medium may be included in the above-mentioned electronic device; and it may also exist alone without being assembled into the electronic device.

The computer readable medium carries one or more programs which, when executed by the electronic device, cause the electronic device to perform the method described in the above embodiments.

Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware, wherein the name of a unit does not form any limitation to the unit per se in some case.

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

According to one or more embodiments of the present disclosure, an information display method is provided, comprising:
determining bullet comment information to be displayed and a bullet comment space in a display space, wherein the display space is configured to display a target image, and the bullet comment space is a predetermined space area in the display space;
displaying the bullet comment information in the bullet comment space;
wherein a circular or curved bullet track is arranged in advance in the bullet comment space, and at least part of the bullet comment information bends along the bullet track to form curved bullet comments.

According to one or more embodiments of the present disclosure, an information display method is provided, wherein an axial direction of the bullet track is a vertical direction in the display space, the bullet track bends along a first direction, and the first direction is a display direction of the target image; and/or,
the number of bullet tracks is at least two, and there are at least two bullet tracks with different locations in the first direction.

According to one or more embodiments of the present disclosure, an information display method is provided, wherein the bullet comment information comprises at least one of a first-type bullet comment and a second-type bullet comment, and the bullet comment space comprises at least one of a first bullet comment space and a second bullet comment space;
wherein the first-type bullet comment is displayed in the first bullet comment space, and the second-type bullet comment is displayed in the second bullet comment space.

According to one or more embodiments of the present disclosure, an information display method is provided, wherein at least one of the following conditions is met:
the first-type bullet comment comprises interactive information;
the second-type bullet comment comprises non interactive information;
the first bullet comment space has at least two bullet tracks with different locations in the first direction;
spacing distances between adjacent bullet comment information on the bullet track are not exactly the same;
wherein the first direction is a display direction of a target image in the display space.

According to one or more embodiments of the present disclosure, an information display method is provided, wherein displaying the bullet comment information in the bullet comment space comprises at least one of:
controlling the first-type bullet comment to move along the bullet track in the first bullet comment space;
gradually increasing a size of the first-type bullet comment and/or gradually reducing a transparency of the first-type bullet comment if the first-type bullet comment enters the first bullet comment space; and
gradually reducing a size of the first-type bullet comment and/or gradually increasing a transparency of the first-type bullet comment if the first-type bullet comment leaves the first bullet comment space.

According to one or more embodiments of the present disclosure, an information display method is provided, wherein displaying the bullet comment information in the bullet comment space comprises at least one of:
in response to a first-type bullet comment sent by a current user, distinguishing the display style of the first-type bullet comment sent by the current user from the display style of other first-type bullet comments;
in response to the first-type bullet comment sent by the current user, displaying in priority the first-type bullet comment sent by the current user in the first bullet comment space; and
adjusting the number of bullet tracks in the first bullet comment space based on a display effect of the first-type bullet comment.

According to one or more embodiments of the present disclosure, an information display method is provided, wherein displaying the bullet comment information in the bullet comment space comprises:
displaying the first-type bullet comment at at least one predetermined location on the bullet track, and ceasing to display the first-type bullet comment after being displayed for a predetermined time, so as to display a next first-type bullet comment;
in response to a first-type bullet comment sent by a current user, displaying the first-type bullet comment sent by the current user on the most forward bullet track in the first direction in the first bullet comment space; and
evenly distributing the first-type bullet comments in the first bullet comment space based on the post time.

According to one or more embodiments of the present disclosure, an information display method is provided, wherein displaying the bullet comment information in the bullet comment space comprises at least one of:
a bullet track in the second bullet comment space being located on a side of a bullet track in the first bullet comment space facing a first direction;
scrolling-displaying the second-type bullet comment on a bullet track in the second bullet comment space;
adjusting the number of bullet tracks in the second bullet comment space and/or adjusting a spacing distance between second-type bullet comments on the bullet tracks based on display effects of the second-type bullet comments;
simultaneously displaying a maximum of n second-type bullet comments on bullet tracks in the second bullet comment space, and after a new second-type bullet comment is generated, ceasing to display an earliest displayed second-type bullet comment among displayed second-type bullet comments and displaying a newly generated second-type bullet comment on the bullet track;
gradually increasing a size of the second-type bullet comment, reducing a transparency of the second-type bullet comment and/or increasing the movement speed of the second-type bullet comment if the second-type bullet comment enters the second bullet comment space; and
gradually reducing a size of the second-type bullet comment, increasing a transparency of the second-type bullet comment and/or reducing the movement speed of the second-type bullet comment if the second-type bullet comment leaves the second bullet comment space.

According to one or more embodiments of the present disclosure, an information display method is provided, wherein displaying the bullet comment information in the bullet comment space comprises at least one of:
scrolling-displaying the second-type bullet comment in the form of a curved bullet comment along a second direction, the second direction being perpendicular to the first direction;
simultaneously displaying a maximum of m second-type bullet comments in the second bullet comment space, and after a new second-type bullet comment is generated, ceasing to display an earliest displayed second-type bullet comment among displayed second-type bullet comments and displaying a newly generated second-type bullet comment in the second bullet comment space; and
adjusting a spacing distance between second-type bullet comments along the second direction in the second bullet comment space and/or adjusting the number of bullet tracks in the second direction based on display effects of the second-type bullet comments.

According to one or more embodiments of the present disclosure, an information display method is provided, wherein the display space is virtual reality space, and the target image is a virtual reality image.

According to one or more embodiments of the present disclosure, an information display apparatus is provided, comprising:
a determining unit configured for determining bullet comment information to be displayed and a bullet comment space in a display space, wherein the display space is configured to display a target image, and the bullet comment space is a predetermined space area in the display space;
a display unit configured for displaying the bullet comment information in the bullet comment space;
wherein a circular or curved bullet track is arranged in advance in the bullet comment space, and at least part of the bullet comment information bends along the bullet track to form curved bullet comments.

According to one or more embodiments of the present disclosure, a terminal is provided, comprising: at least one memory and at least one processor;
wherein the at least one memory is for storing program code, and the at least one processor is for calling the program code stored in the at least one memory to perform any of the methods described above.

According to one or more embodiments of the present disclosure, a computer readable storage medium is provided, wherein the computer readable storage medium is for storing program code which, when executed by a processor, causes the processor to perform any of the methods described above.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

1. An information display method, comprising:
determining bullet comment information to be displayed and a bullet comment space in a display space, wherein the display space is configured to display a target image, and the bullet comment space is a predetermined space area in the display space; and
displaying the bullet comment information in the bullet comment space;
wherein a circular or curved bullet track is arranged in advance in the bullet comment space, and at least part of the bullet comment information bends along the bullet track to form curved bullet comments.

2. The method of claim 1, wherein
an axial direction of the bullet track is a vertical direction in the display space, the bullet track bends along a first direction, and the first direction is a display direction of the target image; and/or,
the number of bullet tracks is at least two, and there are at least two bullet tracks with different locations in the first direction.

3. The method of claim 1, wherein
the bullet comment information comprises at least one of a first-type bullet comment and a second-type bullet comment, and the bullet comment space comprises at least one of a first bullet comment space and a second bullet comment space;
wherein the first-type bullet comment is displayed in the first bullet comment space, and the second-type bullet comment is displayed in the second bullet comment space.

4. The method of claim 3, wherein at least one of the following conditions is met:
the first-type bullet comment comprises interactive information;
the second-type bullet comment comprises non interactive information;
the first bullet comment space has at least two bullet tracks with different locations in the first direction; or
spacing distances between adjacent bullet comment information on the bullet track are not exactly the same;
wherein the first direction is a display direction of a target image in the display space.

5. The method of claim 3, wherein displaying the bullet comment information in the bullet comment space comprises at least one of the following:
controlling the first-type bullet comment to move along the bullet track in the first bullet comment space;
gradually increasing a size of the first-type bullet comment and/or gradually reducing a transparency of the first-type bullet comment if the first-type bullet comment enters the first bullet comment space; or
gradually reducing a size of the first-type bullet comment and/or gradually increasing a transparency of the first-type bullet comment if the first-type bullet comment leaves the first bullet comment space.

6. The method of claim 3, wherein displaying the bullet comment information in the bullet comment space comprises at least one of:
in response to a first-type bullet comment sent by a current user, distinguishing the display style of the first-type bullet comment sent by the current user from the display style of other first-type bullet comments;
in response to the first-type bullet comment sent by the current user, displaying in priority the first-type bullet comment sent by the current user in the first bullet comment space; and
adjusting the number of bullet tracks in the first bullet comment space based on a display effect of the first-type bullet comment.

7. The method of claim 3, wherein displaying the bullet comment information in the bullet comment space comprises:
displaying the first-type bullet comment at at least one predetermined location on the bullet track, and ceasing to display the first-type bullet comment after being displayed for a predetermined time, so as to display a next first-type bullet comment;
in response to a first-type bullet comment sent by a current user, displaying the first-type bullet comment sent by the current user on the most forward bullet track in the first direction in the first bullet comment space; and
evenly distributing the first-type bullet comments in the first bullet comment space based on the post time.

8. The method of claim 3, wherein displaying the bullet comment information in the bullet comment space comprises at least one of the following:
a bullet track in the second bullet comment space being located on a side of a bullet track in the first bullet comment space facing a first direction;
scrolling-displaying the second-type bullet comment on a bullet track in the second bullet comment space;
adjusting the number of bullet tracks in the second bullet comment space and/or adjusting a spacing distance between second-type bullet comments on the bullet tracks based on display effects of the second-type bullet comments;
simultaneously displaying a maximum of n second-type bullet comments on bullet tracks in the second bullet comment space, and after a new second-type bullet comment is generated, ceasing to display an earliest displayed second-type bullet comment among displayed second-type bullet comments and displaying a newly generated second-type bullet comment on the bullet track;
gradually increasing a size of the second-type bullet comment, reducing a transparency of the second-type bullet comment and/or increasing the movement speed of the second-type bullet comment if the second-type bullet comment enters the second bullet comment space; or
gradually reducing a size of the second-type bullet comment, increasing a transparency of the second-type bullet comment and/or reducing the movement speed of the second-type bullet comment if the second-type bullet comment leaves the second bullet comment space.

9. The method of claim 3, wherein displaying the bullet comment information in the bullet comment space comprises at least one of:
scrolling-displaying the second-type bullet comment in the form of a curved bullet comment along a second direction, the second direction being perpendicular to the first direction;
simultaneously displaying a maximum of m second-type bullet comments in the second bullet comment space, and after a new second-type bullet comment is generated, ceasing to display an earliest displayed second-type bullet comment among displayed second-type bullet comments and displaying a newly generated second-type bullet comment in the second bullet comment space; and
adjusting a spacing distance between second-type bullet comments along the second direction in the second bullet comment space and/or adjusting the number of bullet tracks in the second direction based on display effects of the second-type bullet comments.

10. The method of claim 1, wherein
the display space is virtual reality space, and the target image is a virtual reality image.

11. (canceled)

12. A terminal device, comprising:
at least one memory and at least one processor;
wherein the at least one memory stores program code that are executed by;
the at least one processor to cause the terminal device to perform actions comprising:
determining bullet comment information to be displayed and a bullet comment space in a display space, wherein the display space is configured to display a target image, and the bullet comment space is a predetermined space area in the display space; and
displaying the bullet comment information in the bullet comment space;
wherein a circular or curved bullet track is arranged in advance in the bullet comment space, and at least part of the bullet comment information bends along the bullet track to form curved bullet comments.

13. A non-transitory computer readable storage medium, wherein the computer readable storage medium is for storing program code which, when executed by a processor, causes the processor to perform actions comprising:
determining bullet comment information to be displayed and a bullet comment space in a display space, wherein the display space is configured to display a target image, and the bullet comment space is a predetermined space area in the display space; and
displaying the bullet comment information in the bullet comment space;
wherein a circular or curved bullet track is arranged in advance in the bullet comment space, and at least part of the bullet comment information bends along the bullet track to form curved bullet comments.

14. The electronic device of claim 12, wherein
an axial direction of the bullet track is a vertical direction in the display space, the bullet track bends along a first direction, and the first direction is a display direction of the target image; and/or,
the number of bullet tracks is at least two, and there are at least two bullet tracks with different locations in the first direction.

15. The electronic device of claim 12, wherein
the bullet comment information comprises at least one of a first-type bullet comment and a second-type bullet comment, and the bullet comment space comprises at least one of a first bullet comment space and a second bullet comment space;
wherein the first-type bullet comment is displayed in the first bullet comment space, and the second-type bullet comment is displayed in the second bullet comment space.

16. The electronic device of claim 15, wherein at least one of the following conditions is met:
the first-type bullet comment comprises interactive information;
the second-type bullet comment comprises non interactive information;
the first bullet comment space has at least two bullet tracks with different locations in the first direction; or
spacing distances between adjacent bullet comment information on the bullet track are not exactly the same;
wherein the first direction is a display direction of a target image in the display space.

17. The electronic device of claim 15, wherein displaying the bullet comment information in the bullet comment space comprises at least one of the following:
controlling the first-type bullet comment to move along the bullet track in the first bullet comment space;
gradually increasing a size of the first-type bullet comment and/or gradually reducing a transparency of the first-type bullet comment if the first-type bullet comment enters the first bullet comment space; or
gradually reducing a size of the first-type bullet comment and/or gradually increasing a transparency of the first-type bullet comment if the first-type bullet comment leaves the first bullet comment space.

18. The electronic device of claim 15, wherein displaying the bullet comment information in the bullet comment space comprises at least one of:
in response to a first-type bullet comment sent by a current user, distinguishing the display style of the first-type bullet comment sent by the current user from the display style of other first-type bullet comments;
in response to the first-type bullet comment sent by the current user, displaying in priority the first-type bullet comment sent by the current user in the first bullet comment space; and
adjusting the number of bullet tracks in the first bullet comment space based on a display effect of the first-type bullet comment.

19. The electronic device of claim 15, wherein displaying the bullet comment information in the bullet comment space comprises:
displaying the first-type bullet comment at at least one predetermined location on the bullet track, and ceasing to display the first-type bullet comment after being displayed for a predetermined time, so as to display a next first-type bullet comment;
in response to a first-type bullet comment sent by a current user, displaying the first-type bullet comment sent by the current user on the most forward bullet track in the first direction in the first bullet comment space; and
evenly distributing the first-type bullet comments in the first bullet comment space based on the post time.

20. The electronic device of claim 15, wherein displaying the bullet comment information in the bullet comment space comprises at least one of the following:
a bullet track in the second bullet comment space being located on a side of a bullet track in the first bullet comment space facing a first direction;
scrolling-displaying the second-type bullet comment on a bullet track in the second bullet comment space;
adjusting the number of bullet tracks in the second bullet comment space and/or adjusting a spacing distance between second-type bullet comments on the bullet tracks based on display effects of the second-type bullet comments;
simultaneously displaying a maximum of n second-type bullet comments on bullet tracks in the second bullet comment space, and after a new second-type bullet comment is generated, ceasing to display an earliest displayed second-type bullet comment among displayed second-type bullet comments and displaying a newly generated second-type bullet comment on the bullet track;
gradually increasing a size of the second-type bullet comment, reducing a transparency of the second-type bullet comment and/or increasing the movement speed of the second-type bullet comment if the second-type bullet comment enters the second bullet comment space; or
gradually reducing a size of the second-type bullet comment, increasing a transparency of the second-type bullet comment and/or reducing the movement speed of the second-type bullet comment if the second-type bullet comment leaves the second bullet comment space.

21. The electronic device of claim 15, wherein displaying the bullet comment information in the bullet comment space comprises at least one of:
scrolling-displaying the second-type bullet comment in the form of a curved bullet comment along a second direction, the second direction being perpendicular to the first direction;
simultaneously displaying a maximum of m second-type bullet comments in the second bullet comment space, and after a new second-type bullet comment is generated, ceasing to display an earliest displayed second-type bullet comment among displayed second-type bullet comments and displaying a newly generated second-type bullet comment in the second bullet comment space; and
adjusting a spacing distance between second-type bullet comments along the second direction in the second bullet comment space and/or adjusting the number of bullet tracks in the second direction based on display effects of the second-type bullet comments.
